(19) United States
(12) Patent Application Publication
(10) Pub. No.: US 2007/0187909 A1
(43) Pub. Date: Aug. 16, 2007

(54) Clamping Apparatus

(75) Inventor: Ferdinand Troxler, Schenkon (CH)

Correspondence Address: MAGINOT, MOORE & BECK, LLP;CHASE TOWER, 111 MONUMENT CIRCLE, SUITE 3250, INDIANAPOLIS, IN, 46204, US

(73) Assignee: F-TOOL INTERNATIONAL AG, Schoeftland (CH)

(21) Appl. No.: 11/624,348

(22) Filed: Jan. 18, 2007

(30) Foreign Application Priority Data
Jan. 30, 2006 (CH) 00151/06

(51) Int. Cl. B23B 31/12

(52) U.S. Cl. 279/76

(57) ABSTRACT

The clamping apparatus comprises a chuck member for holding an element to be clamped thereto that is provided with a centering disc member that is elastically resilient in Z-direction and that defines at least one aperture. The element to be clamped is provided with a clamping bolt member having a centering portion in the shape of a truncated cone. Upon insertion of the clamping bolt member into the aperture of the centering disc member, the centering portion engages the edge of the aperture in the centering disc and aligns the element to be clamped in the X- and Y-directions. The centering disc member is located behind an end plate member of the chuck member, and the surface of the end plate member constitutes the Z-reference for the element to be clamped. The end plate member is provided with an aperture through which the clamping bolt member can be inserted into the aperture of the centering disc member.

### BACKGROUND OF THE INVENTION

The present invention refers to a clamping apparatus comprising a chuck member adapted to hold an element to be clamped and provided with first centering means, and an element to be clamped having second centering means adapted to cooperate with the first centering means provided on the chuck member such that the element to be clamped is aligned in the X- and Y-directions upon clamping the element to the chuck member.

Such clamping apparatuses are used preferably for clamping an element in a well defined position in the region of the machining area of a machine tool, whereby the element can be constituted by a work piece, a tool or a pallet adapted to receive a work piece or tool. Usually, the chuck member is attached to a machine table in the machining area of the machine tool, while the element to be clamped is releaseably attached to the chuck member.

The document EP-A-111 092 discloses a clamping apparatus for establishing a torque proof connection between a work piece and a machine tool. The clamping apparatus comprises two coupling members, one of them being in the form of a chuck member and attached to the machine tool, while the other one constitutes a pallet and receives the work piece to be machined. The coupling member attached to the machine tool is provided with a centrally located positioning pin as well as with an eccentrically located catch pin. The coupling member adapted to receive the work piece, i.e. the aforementioned pallet, is provided with a number of spacers or stand-offs serving as a Z-axis reference as well as with a coupling disc, having a central opening as well as an eccentric, essentially oval opening. Upon clamping the one coupling element to the other one, the central positioning pin and the eccentric catch pin engage the two corresponding openings in the coupling disc and align the two coupling elements with regard to each other in X- and Y-directions as well as with regard to the angular orientation, while the stand-offs of the one coupling member come to a rest on the other coupling member and thereby define the relative position of the two coupling members in the direction of the Z-axis.

In such a coupling apparatus, the coupling disc is exposed to the outside and, thereby, runs the risk of being mechanically damaged. Moreover, all pallets to be used in such a clamping apparatus have to be provided with such a coupling disc; this requirements increases the total costs of a clamping system since, usually, a plurality of pallet members are assigned to a particular chuck member.

### SUMMARY OF THE INVENTION

One embodiment of the invention provides a clamping apparatus comprising a chuck member adapted to hold an element to be clamped and provided with first centering means, and an element to be clamped having second centering means adapted to cooperate with the first centering means provided on the chuck member such that the element to be clamped is aligned in X- and Y-directions upon clamping the element to the chuck member.

The first centering means includes a centering disc member attached to the chuck member to be elastically resiliently deformable in the direction of the Z-axis and provided with a centering aperture. The second centering means includes a clamping bolt member having a centering portion adapted to engage the edges of the centering disc when the centering bolt is inserted into the centering aperture of the centering disc upon attaching the element to be clamped to the chuck member. The chuck member has at least one stop surface adapted to define a Z-axis reference for the element to be clamped as well a means for fixing the element to be clamped to the chuck member.

In a further embodiment, the clamping apparatus may have two chuck members adapted to hold an element to be clamped that is provided with two clamping bolt members. Each chuck member has a centering disc member attached thereto in such way as to be elastically resiliently deformable in the direction of the Z-axis and provided with a centering aperture. One of the clamping bolt members has a centering portion adapted to align the clamping bolt member in the X- and Y-directions upon engaging the centering aperture in said centering disc member, and the other one of the clamping bolt members has a centering portion adapted to align the clamping bolt member in the X- or Y-direction only upon engaging the centering aperture in the centering disc member.

Alternatively, one of the centering disc members may have a centering aperture adapted to align one of the clamping bolt members in the X- and Y-directions upon engaging the clamping bolt member cooperating therewith. The other one of the centering disc members has a centering aperture adapted to align the other one of the clamping bolt members in the X- or Y-direction only upon engaging the clamping bolt member cooperating therewith.

It is an object of the invention to provide a clamping apparatus having a chuck member and an element to be clamped, in which the element to be clamped can be provided quickly and easily with centering means required for exactly positioning relative to the chuck member without the need for laboriously machining the element to be clamped. Thereby, these centering means are of simple design to be manufactured at low costs; nevertheless, the element is able to be clamped to the chuck member with very high absolute and repetitive accuracy.

### BRIEF DESCRIPTION OF THE DRAWINGS

In the following, an embodiment of the apparatus according to the invention will be further described, with reference to the accompanying drawings, in which:

FIG. 1 shows a perspective, exploded view of a clamping apparatus, particularly of a chuck member and an element to be clamped thereon;

FIG. 2 shows a longitudinal sectional view of the chuck member and the element before clamping; and

FIG. 3 shows a longitudinal sectional view of the chuck member and the element after clamping.

### DESCRIPTION OF A PREFERRED EMBODIMENT

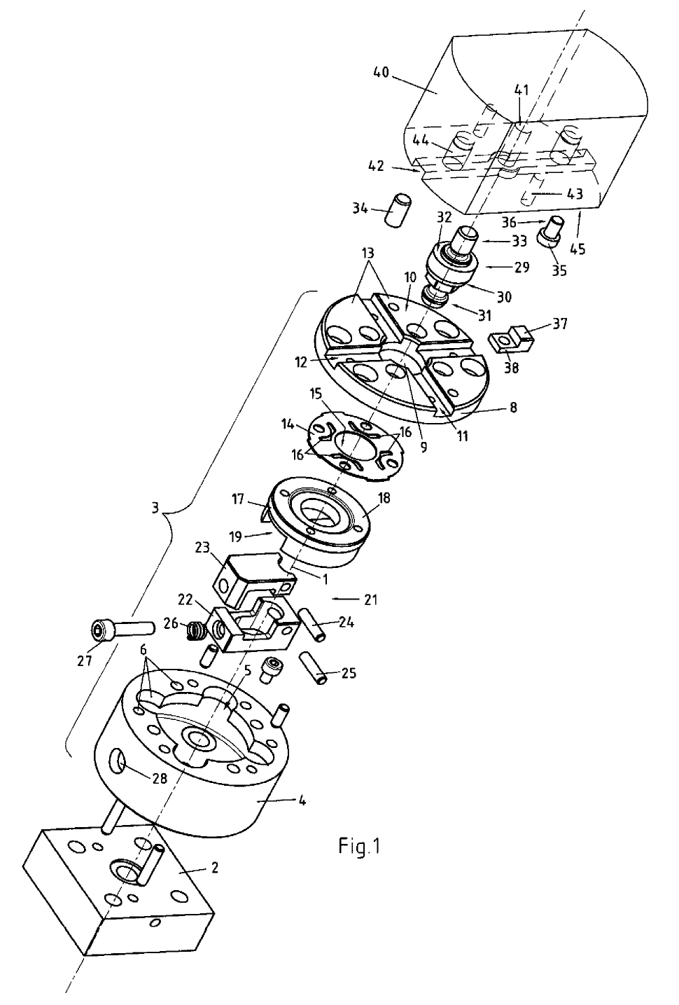

FIG. 1 shows an exploded perspective view of the clamping apparatus adapted to clamp, for example, an element 40 on a chuck member 3. The expression “element” shall be understood as a general expression for all kinds of parts that can be attached to the chuck member 3; particularly, the element 40 could be a work piece, a tool or a pallet. Moreover, it should be noted that the elements required for connecting the components of the chuck, as for example screws, are not shown in the drawing.

A longitudinal central axis, running through the center of the chuck 3 as well as of the clamped element 40 and being identical to the Z-axis, is generally designated by reference numeral 1. Located below the chuck 3, as seen in FIG. 1 of the drawings, is a plate member 2 to which the chuck can be attached. The plate member 2 shall be representative for a support means provided on the machine tool in which the apparatus is used; particularly, the support means could be a machine tool table or the quill of the machine tool. However, instead of being attached to the plate member 2, the chuck 3 can be attached to a base plate member, to an adapter plate member or a similar member which, in turn, can be provided with coupling elements for fixing it to a corresponding coupling apparatus.

The chuck member 3 comprises a cylindrical body member 4, provided with a central recess 5 as well as with a plurality of connecting bores, threaded bores etc., globally designated by reference numeral 6. The front cover of the chuck member 3 is constituted by an end plate member 8, provided with a central aperture 9 as well as with grooves 11, 12 running perpendicular to each other and machined into the surface 10 of the end plate member 8. By means of these grooves 11, 12, the surface 10 of the end plate member 8 is subdivided into four sections 13 each having the shape of a sector of a circle. The flat surfaces of these sections 13 constitute the Z-axis stop members for the element 40 to be clamped by the chuck 3. The rear side of the end plate member 8 is provided with a centering disc 14, having a central centering aperture 15 whose edge regions exhibit an elastically resilient behavior. In order to ensure that the edge regions of the central centering aperture 15 exhibit their elastically resilient behavior, the centering disc 14 is provided with slots 16.

When the chuck 3 is in its assembled state, the centering disc 14 is located behind and protected by the end plate member 8. Moreover, a support plate member 17 may be provided, having an annular protruding peripheral rim 18. The centering disc 14 is adapted to rest on that rim 18 in such a way that it can be resiliently deflected in the axial direction towards the plate member 2. The rear side of the support plate member 17 is provided with a groove 19, adapted to receive a clamping mechanism 21 which will be explained in further detail hereinafter. Both the support plate member 17 and the clamping mechanism 21 are received within the central recess 5 of the cylindrical body member 4.

The clamping apparatus further includes at least one clamping bolt 29 as well as an alignment pin 34, an alignment bolt 35 or an alignment cam 37. Preferably, the clamping bolt 29 is provided with a threaded end 33, allowing for a quick attaching of the clamping bolt to the bottom 45 of the element 40 to be clamped in a corresponding, central threaded bore 41. The alignment pin 34 may be pressed into a bore 44 of the element 40 to be clamped, while the alignment bolt 35 is provided, for example, with a thread 36 by means of which it can be attached to a corresponding threaded bore 43 of the element 40 to be clamped. The alignment cam 37 is attached preferably within a groove 11, 12 of the end plate member 8. The alignment pin 34 and the alignment bolt 35, in cooperation with the grooves 11, 12, are adapted to set the angular position of the element 40 to be clamped around the Z-axis 1 in 900 steps. Instead of the grooves 11, 12, if appropriate, apertures, recesses or similar means can be provided.

The element 40 to be clamped comprises, at least partially, a flat bottom surface 45 into which a longitudinal groove 42 is machined. This longitudinal groove 42 can be used, in cooperation with alignment cam 37 fixed to the chuck 3, to set the angular orientation of the element 40 to be clamped in 180° steps around the Z-axis 1. The base portion 38 of the alignment cam 37 is fixed in a groove 11, 12 of the end plate member 8. It is understood that the longitudinal groove 42 is not required, but either the alignment pin 34 or the alignment bolt 35 cooperating with the grooves 11, 12 of the end plate member 8, or the longitudinal groove 42 cooperating with the alignment cam 37 must be provided. Of course, other embodiments of alignment means for setting the angular position of the element 40 around the Z-axis 1 are possible and are contemplated by the present invention.

The clamping bolt 29 is provided with a head portion 31 which can be engaged, as is known in the prior art, by clamping elements of the clamping mechanism 21. Behind the head portion 31, the clamping bolt 29 is provided with a portion 30 in the shape of the jacket of a truncated cone in a specific embodiment. The portion 30 serves to align the clamping bolt 29 and, thereby, the element 40 connected therewith, in the X- and Y-directions with the help of the centering disc 14. Thus, the portion 30 serves for exactly aligning the clamping bolt 29 in the X-Y plane extending parallel to the surface 10 of the end plate member 8. Moreover, the rear portion of the clamping bolt 29 is provided with an annular stop surface 32 which rests on the flat surface 45 of the element 40 to be clamped once the clamping bolt 29 is fixed to the element 40 to be clamped. The axial distance between the annular stop surface 32 and the portion 30 is matched to the chuck 3, as will be further explained herein.

The clamping mechanism 21 for clamping the clamping bolt 29 may include two clamping elements in the form of L-shaped sliders 22, 23, that are movable relative to each other by means of a screw 27. The screw 27 is accessible, once the chuck 3 is assembled, through a radial bore 28 provided in the cylindrical body member 4. Each of the sliders 22, 23 is provided with a transverse pin 24, 25 that can rest against the head portion 31 of the clamping bolt 29 or can be moved away therefrom when the two sliders 22, 23 are moved towards or away from each other, respectively, under the influence of the rotating screw 27.

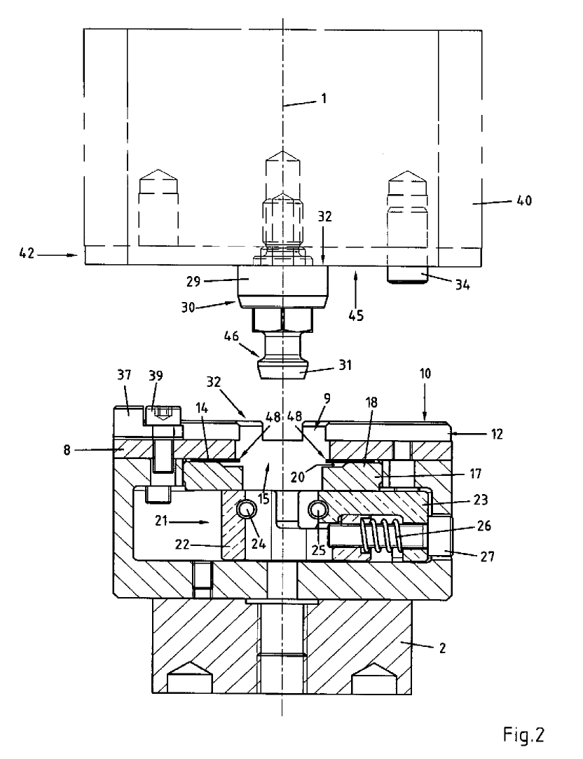

FIG. 2 shows a longitudinal sectional view of the chuck 3 as well as a side view of the element 40 to be clamped. In this view the clamping mechanism 21 can be seen in which the two sliders 22, 23 are movable relative to each other by means of the screw 27. Between the two sliders 22, 23, a compression spring 26 is inserted, biased to move the two sliders 22, 23 away from each other. Moreover, in this view of FIG. 2, the centering disc 14 can be seen as it rests on the peripheral rim 18 of the support plate member 17. A gap 20 is provided between the central portion of the centering disc 14 and the central portion of the support plate member 17, allowing for an elastically resilient deflection of the edge portion of the centering disc 14, surrounding the aperture 15, in the Z-direction, namely towards the plate member 2.

In order to clamp the element 40 to the chuck 3, the clamping bolt 29 attached to the element 40 to be clamped is inserted into the central aperture 9 of the end plate member 8, whereby the alignment pin 34 is aligned with the groove 12 of the end plate member 8. Alternatively, the alignment cam 37 may be aligned with the groove 42 provided in the element 40. Upon inserting the clamping bolt 29 into the central opening 9 of the end plate member 8, the truncated cone shaped centering portion 30 contacts the edge 48 of the radial aperture 15 of the centering disc 14 and aligns the clamping bolt 29, and thereby the element 40 to be clamped, in the X- and Y-directions. The angular orientation of the element 40 to be clamped around the Z-axis is set either by the aligning pin 34 or by the aligning cam 37. In certain embodiments of the invention, only the one or the other one of the aligning elements 34, 37 is used. The aligning cam 37 is attached to the end plate member 8 by means of a screw 39. In place of the aligning pin 34 and the aligning cam 37, respectively, an alignment bolt can be used, such as bolt 35 previously mentioned.

The clamping bolt 29 is matched to the chuck 3 in such a way that an axial gap between a few hundredths and a few tenths of a millimeter remains between the annular stop surface 32 of the clamping bolt, and thereby between the flat bottom surface 45 of the element 40 to be clamped and the surface 10 of the end plate member 8 when the truncated cone shaped centering portion 30 of the clamping bolt 29 fully rests on the edge 48 of the aperture 15 of the centering disc 14. In other words, if the element 40 to be clamped is loosely inserted into the chuck member 3, the bottom surface 45 of the element 40 does not touch the Z-axis stop surface 10 of the chuck 3, but a gap of a few hundredths to a few tenths of a millimeter remains.

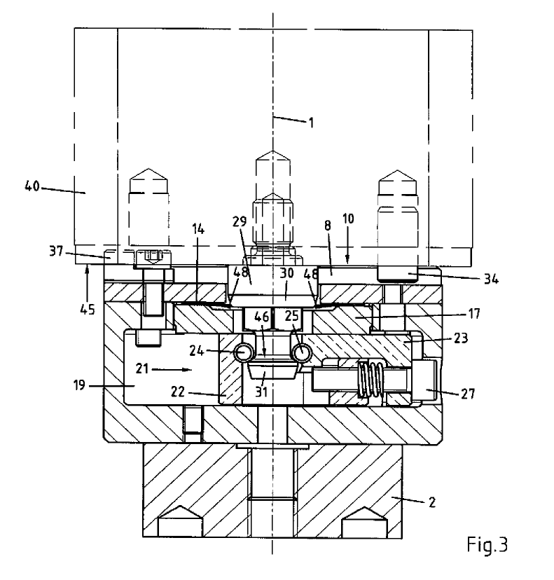

FIG. 3 shows a longitudinal sectional view of the chuck 3 with the element 40 clamped thereto. By rotating the screw 27, the two sliders 23, 24 of the clamping mechanism 21 are moved towards each other in such a way that the two pins 24, 25 approach each other. Thereby, the pins 24, 25 are pressed against a cone-shaped portion 46 of the clamping bolt 29, located at the rear side of the head portion 31 thereof, with the result that the clamping bolt 29 and, thereby the element 40 to be clamped, is pulled towards the chuck 3 until the element 40 rests with its flat bottom surface 45 on the top side 10 of the end plate member 8. Thereby, the position of the element 40 to be clamped is set also in the Z-direction. After the element 40 has been clamped to the chuck 3, the centering disc 14 may elastically deform in a direction towards the plate member 2.

In accordance with the present embodiment of the clamping apparatus a very accurate positioning of an element 40 to be clamped can be realized with regard to the chuck 3, both in the X- and Y-directions as well as with regard to its angular orientation around the Z-axis, since the positioning of the element 40 to be clamped is performed essentially without any force being applied by the clamping mechanism 21. Once the element 40 to be clamped is accurately positioned with regard to the chuck 3, the element 40 to be clamped has only to be pulled towards the chuck 3 in the Z-direction by small dimension under the influence of the clamping mechanism 21, and then clamped to the chuck 3. Once clamped, the element 40 rests with a large surface on the surface 10 of the end plate member 8, thus being rigidly fixed to the chuck 3. Since the clamping mechanism 21 is floatingly received in the groove 19 of the support plate member 17, it can center itself with regard to the clamping bolt 29 during the clamping operation.

Certain advantages of a clamping apparatus according to the invention may be seen in that the relatively expensive and sensitive centering elements are located on the chuck 3, while the simpler and less expensive centering elements cooperating therewith are located on the element 40 to be clamped. Moreover, the somewhat delicate centering disc 14 is attached to the chuck 3 behind the end plate member 8 and protected thereby. Thus, the most important centering element, i.e. the centering disc 14, is protected from exterior mechanical influences to a far extent and the element 40 can be repeatedly clamped to the chuck in a very accurate way.

The element 40 to be clamped itself can be provided with the elements required for clamping and centering very simply and quickly. In practice, the element 40 to be clamped only needs to have an at least partially flat bottom surface 45 as well as at least one threaded bore 41 for attaching the clamping bolt 29. Additionally, at least one further means or element may be provided which can be used to directly or indirectly set the angular position of the element 40 around the Z-axis 1. This means or element can be constituted, for example, by a further threaded bore 43, a pin bore 44 or a groove 42 provided in the bottom surface 45 of the element 40 to be clamped. The threaded bore 43 and the pin bore 44, respectively, are adapted to receive and fix an alignment bolt 35 and an alignment pin 34, respectively, in each case cooperating with a groove 11, 12 provided in the end plate member 8 of the chuck 3. The groove 42 serves for aligning the element 40 to be clamped regarding its angular position around the Z-axis by cooperating with a alignment cam member 37 provided on the chuck 3. As has been previously mentioned, only either an alignment pin 34 or an alignment bolt 35 or an alignment cam 37 has to be provided for cooperation with the corresponding groove or aperture to establish this angular position.

Due to the fact that the means required for centering the element 40 to be clamped in the X- and Y-directions are situated directly on the clamping bolt 29, any separate centering means usually required by the prior art for the centering in X- and Y-directions can be omitted. Since several elements 40 to be clamped may be used with a single chuck 3, the total cost of the device can be lowered because the comparatively expensive centering means are located on the chuck 3, thus having to be provided but once, while the relatively inexpensive centering means are located on each element 40 to be clamped. In this connection, attention is drawn to the fact that a centering portion 30 is located directly on the clamping bolt 29.

With a clamping apparatus in accordance with the present invention, an element to be clamped can be attached to a chuck with a high absolute and repetitive accuracy in the region of a few thousands of a millimeter both in the X- and Y-directions as well as with regard to its angular orientation around the Z-axis.

In alternative embodiments, instead of using a single chuck 3, as has been described herein before, it is also possible to use a plurality of chucks. For example, an embodiment of a clamping apparatus could be provided with two chucks attached to a common base plate member or combined in a common body member, thus forming a chuck member assembly. In any case, however, each of these chuck members may be provided with a centering disc as well as with a clamping mechanism. The element to be clamped would then be provided with a number of clamping bolts equal to the number of chuck members. In order to avoid a geometrically redundant positioning of the element to be clamped with regard to the chuck member assembly in the case of two chuck members, one of the chuck members is preferably adapted to set the position in both the X- and Y-directions, while the other chuck member may sets the angular orientation around the Z-axis and only clamp the element without any X-Y-positioning.

In accordance with one embodiment in which a clamping apparatus assembly includes two chuck members, the first chuck member may be configured as described herein before, except that no alignment pin, bolt or cam is provided. In other words, the clamping bolt is centered in the X- and Y-directions by means of the centering disc when it is inserted into the first chuck member. The second chuck member serves, on the one hand, for clamping the clamping bolt of the element to be clamped and, on the other hand, for setting the angular position of the element to be clamped around the Z-axis. To this end, the centering portion 30 of the clamping bolt 29 may be configured such that it engages the edge 48 of the centering aperture 15 in the centering disc 14 only along two opposite lateral surfaces, such that the clamping bolt can laterally move along a line running from the first chuck member to the second chuck member. This ensures a high positional accuracy upon clamping the element to the chuck member assembly even under the worst conditions, for example in the case of temperature-related dimension changes of the element to be clamped. In order to make possible a slight lateral movement of the clamping bolt with regard to the chuck member, for example, the aperture in the centering disc of the second chuck member can be oval in such a way that the clamping bolt rests on the two straight lateral edges of the oval aperture while the bolt moves along the line running from the center of the first chuck member to the center of the second chuck member.

The clamping mechanism 21, as described herein before, in which the two clamping elements, i.e. the two sliders 22, 23 are floatingly received in the groove 19 of the support plate member 17, is particularly suitable for clamping an element provided with several clamping bolts, since the clamping mechanism 21 aligns itself with regard to the assigned clamping bolt during the clamping operation.

It is understood that a clamping apparatus can be realized that has more than two chuck members. For clamping very large elements, for example a clamping apparatus having four chuck members can be provided. In this case, a first chuck member serves for aligning its assigned clamping bolt in the X- and Y-directions, while a second chuck member aligns its assigned clamping bolt only in one direction, for example in the X-direction. The remaining two chuck members, finally, serve only for pulling in and fixing the assigned clamping bolts. In the latter case, i.e. in the case of the third and forth chuck member, a clamping bolt having a machined off centering portion 30 can be used, so that it does not engage the central aperture in the centering disc. It is understood that all four chuck members are adapted to pull in and clamp their assigned clamping bolts, resulting in an alignment of the element to be clamped in Z-direction.

If the problems of geometric redundant positioning are solved on the level of the clamping bolt and the element to be clamped, respectively, each chuck member of a multiple chuck member assembly can be used also for clamping a simple element, i.e. an element to be clamped having only one clamping bolt.

It should be finally noted that a simple screw can be used instead of the clamping mechanism discussed herein above. Such a screw would have to be inserted into a threaded bore provided in the free end face of the clamping bolt and running in the direction of the Z-axis to pull the clamping bolt into the chuck member and to fix it therein.

What is claimed is:

1. A clamping apparatus comprising:
a chuck member adapted to hold an element to be clamped and provided with first centering means;
an element to be clamped provided with second centering means adapted to cooperate with said first centering means provided on said chuck member such that said element to be clamped is aligned in X- and Y-directions upon clamping said element to said chuck member;
said first centering means including a centering disc member attached to said chuck member and configured to be elastically resiliently deformable in the direction of the Z-axis, said centering disc member defining a centering aperture;
said second centering means including a clamping bolt member having a centering portion configured to engage an edge of said centering aperture when said centering bolt is inserted into said centering aperture of said centering disc upon attaching said element to be clamped to said chuck member; and
said chuck member having at least one stop surface adapted to define a Z-axis reference for the element to be clamped as well a means for fixing said element to be clamped to said chuck member.

2. An apparatus according to claim 1 in which said centering aperture is a circular aperture, and in which said centering portion of said clamping bolt member has at least partially the shape of a truncated cone to align said clamping bolt member in the X- and Y-directions by engaging the edge of said circular aperture in said centering disc member.

3. An apparatus according to claim 1 in which said chuck member is provided with an end plate member, the one surface thereof including said Z-axis reference surface for the element to be clamped, said centering disc member being located adjacent to a surface of said end plate member that is opposite to said one surface of said end plate member, and said end plate member defining an aperture through which said clamping bolt member extends into said aperture in said centering disc member upon attaching said element to be clamped to said chuck member.

4. An apparatus according to claim 3 in which said chuck member includes a chuck body member to which said end plate member is attached, whereby said centering disc member is located between said chuck body member and said end plate member.

5. An apparatus according to claim 4 in which said centering disc member is attached to said chuck body member by a support plate member.

6. A clamping apparatus according to claim 5 in which said support plate member is provided with a protruding peripheral rim portion to which said centering disc is connected such that a gap is provided between the central portion of the centering disc and the support plate member, enabling an elastically resilient deformation of the centering disc member towards the support plate member.

7. A clamping apparatus according to claim 5 in which said support plate member is provided with a groove adapted to floatingly receive a clamping mechanism.

8. An apparatus according to claim 7 in which said clamping mechanism includes two slider members movable relative to each other in a direction perpendicular to the Z-axis, each of said slider members including at least one pin member adapted to engage said clamping bolt member provided on said element to be clamped to pull in and retain said clamping bolt member.

9. A clamping apparatus according to claim 3 in which said one surface of said end plate member including said Z-axis reference surface for the element to be clamped is provided with a groove or an aperture adapted to receive a further centering element provided on said element to be clamped and adapted to align the element to be clamped with regard to its angular orientation around the Z-axis.

10. An apparatus according to claim 1 in which said chuck member is provided with at least one eccentrically located aligning element, cooperating with a recess provided on said element to be clamped when said element is clamped to said chuck member and adapted to thereby align said element to be clamped with regard to its angular orientation around the Z-axis.

11. An apparatus according to claim 1 in which said clamping mechanism includes two slider members movable relative to each other in a direction perpendicular to the Z-axis, each of said slider members including at least one pin member adapted to engage said clamping bolt member provided on said element to be clamped to pull in and retain said clamping bolt member.

12. An apparatus according to claim 1 in which said clamping bolt member is exchangeably connected to said element to be clamped.

13. An apparatus according to claim 1 in which said clamping bolt member is provided with a threaded end portion adapted to be screwed into a threaded aperture provided on said element to be clamped.

14. An apparatus according to claim 11 in which said clamping bolt member is provided with an annular stop surface resting on the surface of the element to be clamped when said clamping bolt member is attached to said element to be clamped.

15. An apparatus according to claim 12 in which said clamping bolt member is provided with an annular stop surface resting on the surface of the element to be clamped when said clamping bolt member is attached to said element to be clamped.

16. An apparatus according to claim 1 in which the top surface of said chuck member facing said element to be clamped is provided with two grooves running perpendicularly to each other.

17. An apparatus according to claim 3 in which said one surface of said end plate member including said Z-axis reference surface for the element to be clamped is provided with at least one bore for attaching said clamping body member and at least one further aperture or bore for attaching an aligning element or a recess for receiving an aligning cam member provided on the chuck member.

18. An apparatus according to claim 11 in which said one surface of said end plate member including said Z-axis reference surface for the element to be clamped is provided with at least one bore for attaching said clamping body member and at least one further aperture or bore for attaching an aligning element or a recess for receiving an aligning cam member provided on the chuck member.

19. An apparatus according to claim 3 in which said one surface of said end plate member including, said Z-axis reference surface for the element to be clamped is provided with at least one bore for attaching said clamping body member and at least one further aperture or bore for attaching an aligning element and a recess for receiving an aligning cam member provided on the chuck member.

20. An apparatus according to claim 11 in which said one surface of said end plate member including, said Z-axis reference surface for the element to be clamped is provided with at least one bore for attaching said clamping body member and at least one further aperture or bore for attaching an aligning element and a recess for receiving an aligning cam member provided on the chuck member.

21. A clamping apparatus comprising:
at least two chuck members adapted to hold an element to be clamped that is provided with two clamping bolt members,
each one of said at least two chuck members including a centering disc member attached thereto, said centering disc member being elastically resiliently deformable in direction of the Z-axis and defining a centering aperture,
one of said clamping bolt members having a centering portion adapted to align said clamping bolt member in X- and Y-directions upon engaging said centering aperture in said centering disc member, and the other one of said clamping bolt members having a centering portion adapted to align said clamping bolt member in X- or in Y-direction only upon engaging said centering aperture in said centering disc member.

22. A clamping apparatus comprising:
at least two chuck members adapted to hold an element to be clamped that is provided with two clamping bolt members, each of said clamping bolt members having a centering portion,
each one of said at least two chuck members having a centering disc member attached thereto that is elastically resiliently deformable in direction of the Z-axis and that defines a centering aperture, and
one of said centering disc members having a centering aperture adapted to align one of said clamping bolt members in X- and Y-directions upon engaging the clamping bolt member cooperating therewith, and the other one of said centering disc members having a centering aperture adapted to align the other one of said clamping bolt members in the X- or in Y-direction only upon engaging the clamping bolt member cooperating therewith.
